(19) United States
(12) Patent Application Publication
(10) Pub. No.: US 2018/0051837 A1
(43) Pub. Date: Feb. 22, 2018

(54) Rigid Self-Sealing Pipe Clamp System and Method

(71) Applicant: Robert Guizzo, Calgary (CA)

(72) Inventor: Robert Guizzo, Calgary (CA)

(21) Appl. No.: 15/240,575

(22) Filed: Aug. 18, 2016

(51) Int. Cl. F16L 21/06; F16L 55/172

(52) U.S. Cl. CPC F16L 21/065; F16L 55/172

(57) ABSTRACT

A rigid self-sealing pipe clamp for mating two pipes with a rigid, durable, and simple-to-install injection-molded fitting. Two shells are bolted together on either side of the two pipe ends to be mated, providing a compression fitting which retain the pipe ends and contains the fluid seals. The system may also be used to repair leaking sections of existing pipe by bolting the sealed clamp around the leaking portion. The fitting is constructed to provide both a durable seal and a rigid support so that the fluid connection maintains a consistent at least one alignment and secure coupling over time. The fitting is simple to install and aligns using integrated ridges.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pipe fittings and more specifically relates to a rigid self-sealing pipe clamp.

### 2. Description of Related Art

A pipe fitting is a very short length of pipe or tube, with a socket at one or both ends that allows two pipes or tubes to be joined, welded (steel), brazed or soldered (copper, brass etc.) together. A fitting is used in pipe systems to connect straight pipe or tubing sections, adapt to different sizes or shapes and for other purposes, such as regulating (or measuring) fluid flow. Fittings allow the conveyance of water, gas, or liquid waste in domestic or commercial environments, and also are used for the conveyance of fluids in specialized applications (such as high-pressure, high-flow, high-temperature or hazardous-material). Fittings are also used for lighter-weight piping, especially those flexible enough to be supplied in coiled form.

Fittings require investment in material, time, and tools to install, and are an important part of piping and plumbing systems. Nonetheless, many commercial fittings are not suitable for heavy-duty or long-term installations. Fittings may deteriorate over time, succumb to internal or external stresses, or be installed improperly and thereby fail. The failure of pipe fittings can cause catastrophic damages of property and demand significant time and expense for repairs. Therefore, there is a need for fittings which are both reliable over time and simple to install. A suitable solution is desired.

Several attempts have been made to solve the above-mentioned problems such as those found in U.S. Pat. No. 7,252,293 to Wolf and Ross, and U.S. Pat. No. 4,693,482 to Daigle et al. This art is representative of pipe fittings. However, none of the above inventions and patents, taken either singly or in combination, is seen to describe the invention as claimed.

### BRIEF SUMMARY OF THE INVENTION

In view of the foregoing disadvantages inherent in the known pipe fitting art, the present invention provides a novel rigid self-sealing pipe clamp. The general purpose of the present invention, which will be described subsequently in greater detail is to provide a fluid connection which is both reliable over time and simple to install.

A rigid self-sealing pip clamp is disclosed herein, in a preferred embodiment, combining a left-side coupler shell (defined by an upper clamping shelf, a lower clamping shelf, a cylindrical pipe-clamping body, at least two O-ring receiving channels, an upper shelf seal-receiving channel, a lower shelf seal-receiving channel, at least one alignment ridge, at least one alignment ridge receiving channel, at least four bolt-receiving apertures, all being in function and structural combination), a right side coupler shell (defined by an upper clamping shelf, a lower clamping shelf, a cylindrical pipe-clamping body, at least two O-ring receiving channels, an upper shelf seal-receiving channel, a lower shelf seal-receiving channel, at least one alignment ridge, at least one alignment ridge receiving channel, and at least four bolt-receiving apertures, all being in structural and functional combination), at least two O-rings, at least two shelf seals, at least four bolts, and at least four nuts.

The left-side coupler shell is attachable to the right-side coupler shell, with the O-ring receiving channels of the left-side coupler and the O-ring receiving channels of the right-side coupler being structured to receive the O-rings. The upper shelf-receiving channel of the left-side coupler, the lower shelf-receiving channel of the left-side coupler, the upper shelf-receiving channel of the right-side coupler, and the lower shelf-receiving channel of the right-side coupler are structured to receive the shelf seals. The bolt-receiving apertures of the left-side coupler and the bolt-receiving apertures of the right-side coupler the structured to receive the bolts and nuts.

The left-side coupler shell, right-side coupler shell, and at least two O-rings are each concentric to the first pipe end and the second pipe end when assembled. The left-side coupler shell and the right-side coupler shell are symmetrical in function, and are assembled in mirror image to each other, surrounding the first pipe end and the second pipe end. The O-rings prevent fluid leakage around the two mated pipe ends, and the two shelf seals prevent fluid leakage between the upper clamping shelf of the left-side coupler shell and the upper clamping shelf of the right-side coupler shell, and likewise for the respective lower clamping shelves.

When assembled, the left-side coupler shell and the right-side coupler shell are compressed against the first pipe end, the second pipe end, and each other when the bolts are threaded into the four nuts. In this way, the first pipe end and the second pipe end are held together by the compression of the left-side coupler shell and the right-side coupler shell.

The left-side coupler shell and the right-side coupler shell are aligned on an axis parallel with the first pipe end and the second pipe end by engagement of the one at least one alignment ridges with the opposing at least one alignment ridge-receiving channels on both the upper and lower shelves of the two coupler shells. This pair of at least one alignment engagements ensures consistent and complete seal of both shelf seals.

The left-side coupler shell, right-side coupler shell, O-rings, and shelf seals form a sealed inner volume for communicating a flow of water when assembled around the two pipe ends. The left-side coupler shell and the right-side coupler shell each comprise a semi-cylindrical sleeve encompassing 180° of rotation, including a raised boss at each end of each coupler shell, each including one of the O-ring receiving channels, which are grooves recessed into an inner face of each coupler shell. Together the coupler shells form a resilient annular channel forming a clinched engagement embracing the two pipe ends.

For each coupler shell, the upper and lower clamping shelves are integrally and resiliently attached to the cylindrical pipe-clamping body. This structure causes the cylindrical body to be placed under tension around the pipe ends when the upper and lower shelves are compressed against the shelves of the opposite coupler shell body.

The alignment ridge of the left-side coupler shell the at least one alignment ridge of the right-side coupler shell each engage the alignment ridge-receiving channels of the opposite coupler shells, thereby providing significant structural support and maintaining a proper at least one alignment of the two pipe ends necessary for promoting a fluid-communicating seal over time.

The left-side coupler shell and the right-side coupler shell are structured and arranged to receive, mate, and retain two opposing pipe ends, through the compression of the two coupler shells by application of the bolts and nuts. The O-rings and the shelf seals are engaged and retained by the coupler shells against the pipe ends to form the sealed inner volume. The O-rings and the coupler shells are arranged in functional combination to form a water-tight interior, thereby sealing the fluid contents of both pipe ends.

According to another embodiment, a method for using the rigid self-sealing pipe clamp is also disclosed herein. The method for providing the rigid self-sealing pipe clamp includes the steps of: placing the first pipe end and the second pipe end inside the left-side coupler shell and the right-side coupler shell, aligning the left-side coupler shell and the right-side coupler shell; inserting the four bolts into the four bolt-receiving apertures in the left-side coupler shell and the right-side coupler shell; and compressing the left-side coupler shell and the right-side coupler shell around the first pipe end and the second pipe end by threading the four bolts into the four nuts.

The present invention holds significant improvements and serves as a rigid self-sealing pipe coupler shell. Preferably, a pipe fitting should provide a fluid connection which is both reliable over time and simple to install and, yet would operate reliably and be manufactured at a modest expense. Thus, a need exists for a reliable rigid self-sealing pipe clamp to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, rigid self-sealing pipe clamp system, constructed and operative according to the teachings of the present disclosure.

FIG. 1 shows a perspective view illustrating a rigid self-sealing pipe clamp system during an ‘in-use’ condition according to an embodiment of the disclosure.

FIG. 2 is a perspective view illustrating a disassembled the rigid self-sealing pipe clamp system comprising a rigid self-sealing pipe clamp assembly according to an embodiment of the present invention of the disclosure.

FIG. 3 is an end perspective illustrating the coupler shell according to an embodiment of the present disclosure.

FIG. 4 is a cross-sectional view illustrating an assembled rigid self-sealing pipe clamp according to an embodiment of the present disclosure.

FIG. 5 is a flow diagram illustrating a method of use for the rigid self-sealing pipe clamp according to an embodiment of the present disclosure.

The various embodiments of the present invention will hereinafter be described in conjunction with the appended drawings, wherein like designations denote like elements.

### DETAILED DESCRIPTION

As disclosed above, embodiments of the present disclosure relate to a pipe fitting and more particularly to a rigid self-sealing pipe clamp as used to provide a simpler and more ‘rugged’ (durable) pipe fitting.

Generally speaking, the rigid self-sealing pipe clamp is a two-piece injection molded coupler shell with seals which are useful for both joining and repairing pipes, particularly storm water and sanitary sewer pipes. Installation of this system is easier than other conventional systems. The present invention does not require any form of soldering or adhesive application, and provides a rigid structural support to prevent degradation of the coupling over time. The clamp also provides a positive at least one alignment of the pipes being coupled or repaired to prevent movement of the sealed pipes, promoting the longevity of the connection under stress.

The clamp comprises of two symmetrical coupler shells which are attached to each other on either side of the pipes being coupled or repaired using a series of bolts and nuts which pass through holes drilled in shelves extruded outwardly from the top and bottom of each coupler shell. The bolts are tightened, thereby tensioning the coupler shells, sealing the watertight O-rings, and securely clamping the pipes within. Completed sealing of the clamp is achieved by additional seals lining the separable shelves on the top and bottom of the coupler shells. At least one alignment ridges on either coupler shell mate with channels in the opposite coupler shell, fixing the enclosed pipes in a parallel orientation. Concentric bosses on the coupler shells provide strength as well as house the O-rings sealing the fluid channel.

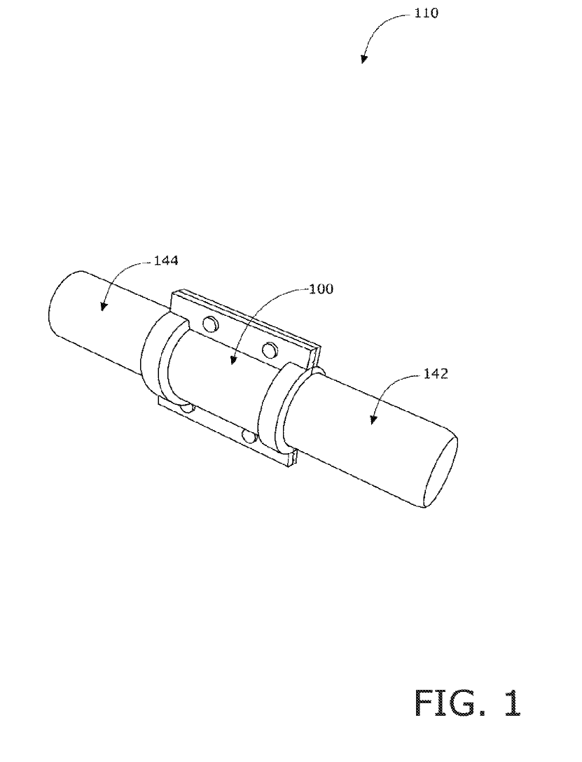

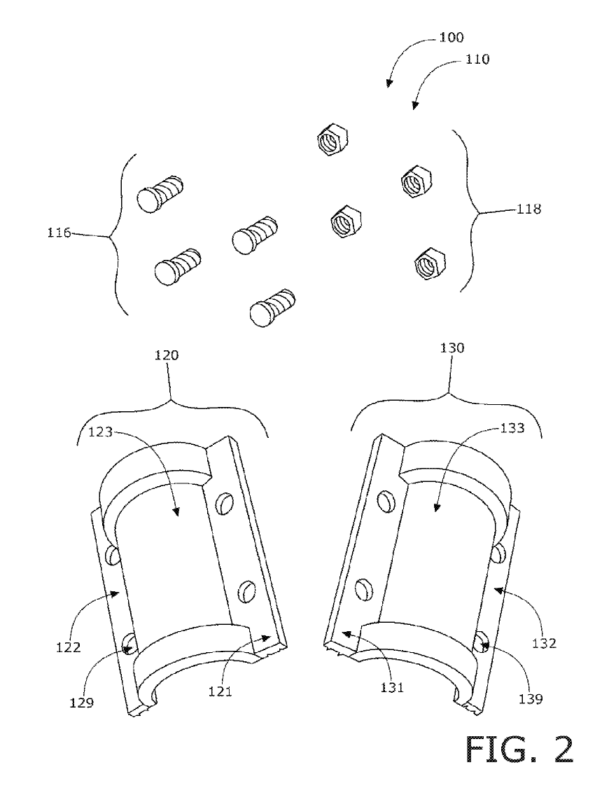

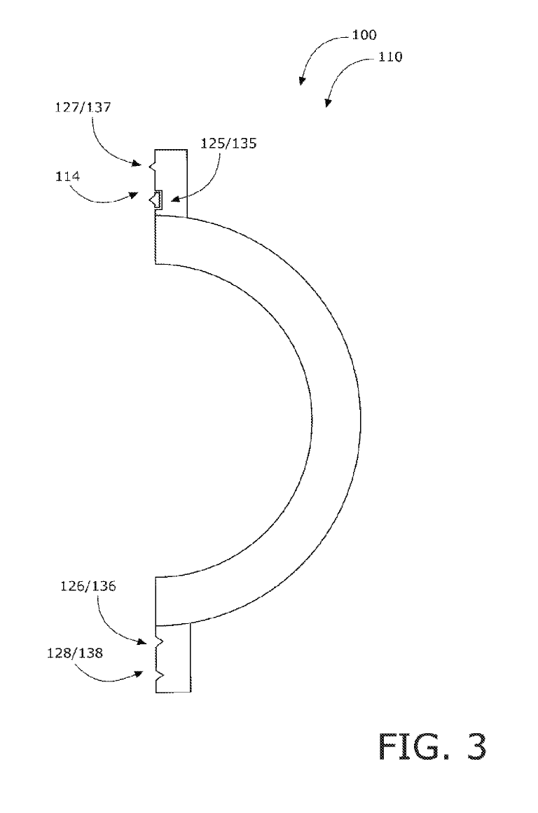

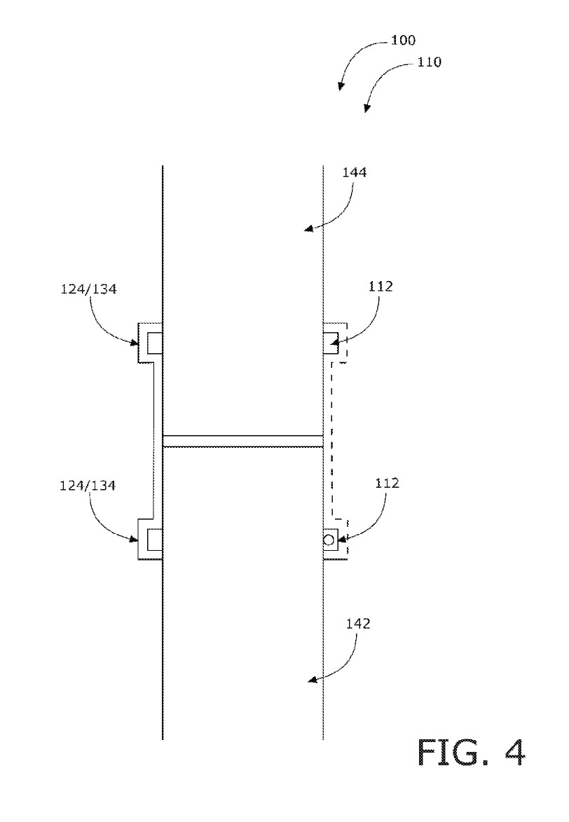

Referring now more specifically to the drawings by numerals of reference there is shown in FIGS. 1-4, various views of rigid self-sealing pipe clamp system 100 comprising left-side coupler shell 120 including and defined by upper clamping shelf 121, lower clamping shelf 122, cylindrical pipe-clamping body 123, at least two O-ring receiving channels 124, upper shelf seal-receiving channel 125, lower shelf seal-receiving channel 126, at least one alignment ridge 127, at least one alignment ridge receiving channel 128, and at least four bolt-receiving apertures 129, upper clamping shelf 121, lower clamping shelf 122, cylindrical pipe-clamping body 123, at least two O-ring receiving channels 124, upper shelf receiving channel 125, said lower shelf receiving channel 126, at least one alignment ridge 127, at least one alignment ridge receiving channel 128, and at least four bolt receiving apertures 129 being in functional and structural combination; right side coupler shell 130 including and defined by upper clamping shelf 131, lower clamping shelf 132, cylindrical pipe-clamping body 133, at least two O-ring receiving channels 134, upper shelf seal-receiving channel 135, lower shelf seal-receiving channel 136, at least one alignment ridge 137, at least one alignment ridge receiving channel 138, and at least four bolt-receiving apertures 139, upper clamping shelf 131, lower clamping shelf 132, cylindrical pipe-clamping body 133, at least two O-ring receiving channels 134, upper shelf receiving channel 135, lower shelf receiving channel 136, at least one alignment ridge 137, at least one alignment ridge receiving channel 138, and at least four bolt receiving apertures 139 being in functional and structural combination; at least two O-rings 112; at least two shelf seals 114; at least four bolts 116; and at least four nuts 118. Alternate fastening means may be used.

Left-side coupler 120 shell is attachable to right-side coupler shell 130. At least two O-ring receiving channels 124 of left-side coupler 120 and at least two O-ring receiving channels 134 of right-side coupler 130 are structured to receive at least two O-rings 112. At least one upper shelf-receiving channel 125 of left-side coupler 120, at least one lower shelf-receiving channel 126 of left-side coupler 120, at least one upper shelf-receiving channel 135 of right-side coupler 130, and at least one lower shelf-receiving channel 136 of right-side coupler 130 are structured to receive at least two shelf seals 114. At least four bolt-receiving apertures 129 of left-side coupler 120 and at least four bolt-receiving apertures 139 of right-side coupler 130 are structured to receive at least four bolts 116 and at least four nuts 118.

Left-side coupler shell 120 and right-side coupler shell 130 are structured and arranged to receive, mate, and retain first pipe end and second pipe end, left-side coupler shell 120 and right-side coupler shell 130 being compressible by application of at least four bolts and at least four nuts. At least two O-rings and at least two shelf seals are engaged and retained by left-side coupler shell 120 and right-side coupler shell 130 against first pipe end and second pipe end. At least two O-rings, left-side coupler shell 120, and right-side coupler shell 130 are arranged in functional combination to form a water-tight interior, thereby sealing the fluid contents of first pipe end 142, second pipe end 144.

Left-side coupler shell 120, right-side coupler shell 130, and at least two O-rings 112 are preferably assembled concentric to first pipe end 142 and second pipe end 144. Left-side coupler shell 120 and right-side coupler shell 130 are symmetrical in function, and are assembled in mirror image to each other, surrounding first pipe 142 end and second pipe end 144. At least two O-rings 112 prevent fluid leakage around first pipe end 142 and second pipe end 144.

At least two shelf seals 114 prevent fluid leakage between upper clamping shelf 121 of left-side coupler shell 120 and upper clamping shelf 131 of right-side coupler shell 130, and between lower clamping shelf 122 of left-side coupler shell 120 and lower clamping shelf 132 of right-side coupler shell 130.

Left-side coupler shell 120 and right-side coupler shell 130 are compressed against first pipe end 142, second pipe end 144, and each other when at least four bolts 116 are threaded into at least four nuts 118. Other fasteners may be used. First pipe end 142 and second pipe end 144 are held together by the compression of left-side coupler shell 120 and right-side coupler shell 130. Left-side coupler shell 120 and right-side coupler shell 130 are aligned on an axis parallel with first pipe end 142 and second pipe end 144 by engagement of at least one alignment ridge 127 of left-side coupler shell 120 with at least one alignment ridge receiving channel 138 of right-side coupler shell 130, and by engagement of at least one alignment ridge 137 of right-side coupler shell 130 with at least one alignment ridge receiving channel 128 of left-side coupler shell 120.

Upper shelf seal-receiving channel 125 of left side coupler shell 120 and lower shelf seal-receiving channel 126 of left side coupler shell 120 are parallel with at least one alignment ridge 127 of left-side coupler shell 120 and at least one alignment ridge receiving channel 128 of left-side coupler shell 120 for the purpose of ensuring consistent and complete seal of at least two shelf seals 114.

Upper shelf seal-receiving channel 135 of right side coupler shell 130 and lower shelf seal-receiving channel 136 of right side coupler shell 130 are parallel with at least one alignment ridge 137 of right-side coupler shell 130 and at least one alignment ridge receiving channel 138 of right-side coupler shell 130 for the purpose of ensuring consistent and complete seal of at least two shelf seals 114.

Left-side coupler shell 120, right-side coupler shell 130, at least two O-rings 112, and at least two shelf seals 114 form a sealed inner volume for communicating a flow of water (or other fluid) when assembled about first pipe end 142 and second pipe end 144. Left-side coupler shell 120 and right-side coupler shell 130 each comprise a semi-cylindrical sleeve encompassing 180° of rotation, including a raised boss at each end of left-side coupler shell 120 and right-side coupler shell 130, each including one of at least two O-ring receiving channels 124 and 134, each comprising a groove recessed into an inner face of left-side coupler shell 120 and right-side coupler shell 130. Left-side coupler shell 120 and right-side coupler shell 130 together comprise a resilient annular channel forming a clinched engagement embracing first pipe end 142 and second pipe end 144.

Upper clamping shelf 121 of left-side coupler shell 120 and lower clamping shelf 122 of left-side coupler shell 120 are integrally and resiliently attached to cylindrical pipe-clamping body 123 of left-side coupler shell 120, cylindrical pipe-clamping body 123 of left-side coupler shell 120 being tensioned about first pipe end 142 and second pipe end 144 when upper clamping shelf 121 of left-side coupler shell 120 and lower clamping shelf 122 of left-side coupler shell 120 are compressed against upper clamping shelf 131 of right-side coupler shell 130 shell and lower clamping shelf 132 of right-side coupler shell 130. Upper clamping shelf 131 of right-side coupler shell 130 and lower clamping shelf 132 of right-side coupler shell 130 are integrally and resiliently attached to cylindrical pipe-clamping body 133 of right-side coupler shell 130, cylindrical pipe-clamping body 133 of right-side coupler shell 130 being tensioned about first pipe end 142 and second pipe end 144 when upper clamping shelf 131 of right-side coupler shell 130 and the lower clamping shelf 132 of right-side coupler shell 130 are compressed against upper clamping shelf 121 of left-side coupler shell 120 and lower clamping shelf 122 of left-side coupler shell 120.

At least one alignment ridge 127 of left-side coupler shell 120 and at least one alignment ridge 137 of right-side coupler shell 130 engage at least one alignment ridge-receiving channel 138 of right-side coupler shell 130 and at least one alignment-receiving ridge 128 of left-side coupler shell 120, thereby providing structural support and maintaining a proper at least one alignment of first pipe end 142 relative to second pipe end 144 necessary to promote a fluid-communicating seal over time.

The rigid self-sealing pipe clamp system 100 may be sold as a kit comprising the following parts: at least two coupler shells; at least two O-rings; at least two shelf seals; at least four bolts; at least four nuts; and at least one set of user instructions. The kit has instructions such that functional relationships are detailed in relation to the structure of the invention (such that the invention can be used, maintained, or the like in a preferred manner).

The rigid self-sealing pipe clamp system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different fastening combinations, parts may be sold separately, etc., may be sufficient.

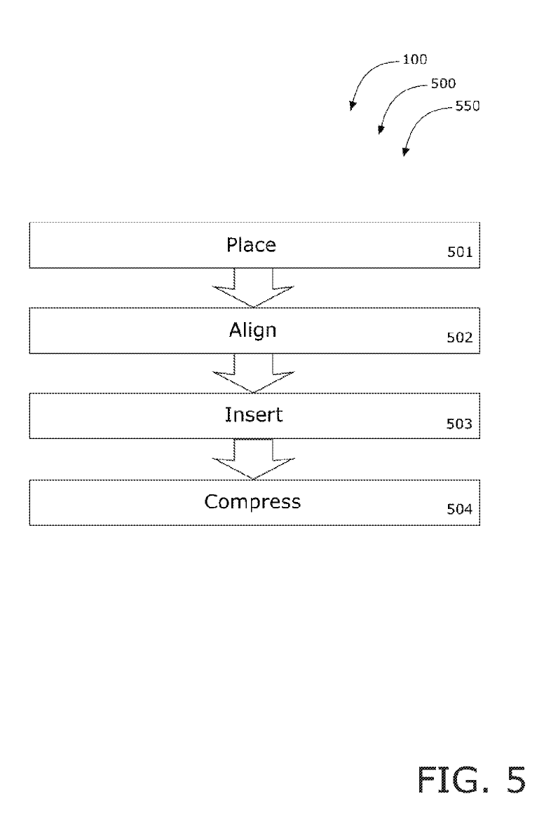

Referring now to FIG. 5 showing a flow diagram 550 illustrating method of use 500 for rigid self-sealing pipe clamp 100 according to an embodiment of the present invention of FIGS. 1-4. As shown, method of use 500 may comprise the steps of: step one 501, placing a first pipe end and a second pipe end inside the left-side coupler shell and the right-side coupler shell; step two 502, aligning the left-side coupler shell and the right-side coupler shell; step three 503, inserting the four bolts into the apertures in the left-side coupler shell and the right-side coupler shell; and step four 504, compressing the left-side coupler shell and the right-side coupler shell around the first pipe end and the second pipe end by threading the four bolts into the four nuts.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A rigid self-sealing pipe clamp system comprising:
a left-side coupler shell and a right-side coupler each including and defined by
an upper clamping shelf;
a lower clamping shelf;
a cylindrical pipe-clamping body;
at least two O-ring receiving channels;
an upper shelf seal-receiving channel;
a lower shelf seal-receiving channel;
at least one alignment ridge;
at least one alignment ridge receiving channel; and
at least four bolt-receiving apertures;
wherein said upper clamping shelf, said lower clamping shelf, said cylindrical pipe-clamping body, said at least two O-ring receiving channels, said upper shelf receiving channel, said lower shelf receiving channel, said at least one alignment ridge, said at least one alignment ridge receiving channel, and said at least four bolt receiving apertures are in functional and structural combination;
at least two O-rings;
at least two shelf seals;
at least four bolts; and
at least four nuts;
wherein said left-side coupler shell is attachable to said right-side coupler shell;
wherein said at least two O-ring receiving channels of said left-side coupler and said at least two O-ring receiving channels of said right-side coupler are structured to receive said at least two O-rings;
wherein said at least one upper shelf-receiving channel of said left-side coupler, said at least one lower shelf-receiving channel of said left-side coupler, said at least one upper shelf-receiving channel of said right-side coupler, and said at least one lower shelf-receiving channel of said right-side coupler are structured to receive said at least two shelf seals;
wherein said at least four bolt-receiving apertures of said left-side coupler and said at least four bolt-receiving apertures of said right-side coupler are structured to receives said at least four bolts and said at least four nuts;
wherein said left-side coupler shell and said right-side coupler shell are structured and arranged to receive, mate, and retain a first pipe end and a second pipe end;
wherein said left-side coupler shell and said right-side coupler shell are compressible by application of said at least four bolts and said at least four nuts;
wherein said at least two O-rings and said at least two shelf seals are engaged and retained by said left-side coupler shell and said right-side coupler shell against said first pipe end and said second pipe end; and
wherein said at least two O-rings, said left-side coupler shell, and said right-side coupler shell are arranged in functional combination to form a water-tight interior, thereby sealing fluid contents of said first pipe end and said second pipe end.

2. The rigid self-sealing pipe clamp system of claim 1 wherein said left-side coupler shell, said right-side coupler shell, and said at least two O-rings are assembled concentric to said first pipe end and said second pipe end.

3. The rigid self-sealing pipe clamp system of claim 1 wherein said left-side coupler shell and said right-side coupler shell are symmetrical structurally, and are assembled in mirror image to each other, surrounding said first pipe end and said second pipe end.

4. The rigid self-sealing pipe clamp system of claim 1 wherein said at least two O-rings prevent fluid leakage around said first pipe end and said second pipe end.

5. The rigid self-sealing pipe clamp system of claim 1 wherein said at least two shelf seals prevent fluid leakage between said upper clamping shelf of said left-side coupler shell and said upper clamping shelf of said right-side coupler shell, and between said lower clamping shelf of said left-side coupler shell and said lower clamping shelf of said right-side coupler shell.

6. The rigid self-sealing pipe clamp system of claim 1 wherein said left-side coupler shell and said right-side coupler shell are compressed against said first pipe end, said second pipe end, and each other when said at least four bolts are threaded into said at least four nuts.

7. The rigid self-sealing pipe clamp system of claim 1 wherein said first pipe end and said second pipe end are held together by compression of said left-side coupler shell and said right-side coupler shell together.

8. The rigid self-sealing pipe clamp system of claim 1 wherein said left-side coupler shell and said right-side coupler shell are aligned on an axis parallel with said first pipe end and said second pipe end by engagement of said at least one alignment ridge of left-side coupler shell with said at least one alignment ridge receiving channel of said right-side coupler shell, and by engagement of said at least one alignment ridge of right-side coupler shell with said at least one alignment ridge receiving channel of said left-side coupler shell.

9. The rigid self-sealing pipe clamp system of claim 1 wherein said upper shelf seal-receiving channel of said left side coupler shell and said lower shelf seal-receiving channel of said left side coupler shell are parallel with said at least one alignment ridge of said left-side coupler shell and said at least one alignment ridge receiving channel of said left-side coupler shell for the purpose of ensuring consistent and complete seal of said at least two shelf seals.

10. The rigid self-sealing pipe clamp system of claim 1 wherein said upper shelf seal-receiving channel of said right side coupler shell and said lower shelf seal-receiving channel of said right side coupler shell are parallel with said at least one alignment ridge of said right-side coupler shell and said at least one alignment ridge receiving channel of said right-side coupler shell for ensuring consistent and complete seal of said at least two shelf seals.

11. The rigid self-sealing pipe clamp system of claim 1 wherein said left-side coupler shell, said right-side coupler shell, said at least two O-rings, and said at least two shelf seals form a sealed inner volume for communicating a flow of water when assembled about said first pipe end and said second pipe end.

12. The rigid self-sealing pipe clamp system of claim 1 wherein said left-side coupler shell and said right-side coupler shell each comprise a semi-cylindrical sleeve encompassing 180° of rotation, including a raised boss at each end of said left-side coupler shell and said right-side coupler shell, each including one of said at least two O-ring receiving channels, each comprising a groove recessed into an inner face of said left-side coupler shell and said right-side coupler shell.

13. The rigid self-sealing pipe clamp system of claim 1 wherein said left-side coupler shell and said right-side coupler shell together comprise a resilient annular channel forming a clinched engagement embracing said first pipe end and said second pipe end.

14. The rigid self-sealing pipe clamp system of claim 1 wherein said upper clamping shelf of said left-side coupler shell and said lower clamping shelf of said left-side coupler shell are integrally and resiliently attached to said cylindrical pipe-clamping body of said left-side coupler shell, said cylindrical pipe-clamping body of said left-side coupler shell being tensioned about said first pipe end and said second pipe end when said upper clamping shelf of said left-side coupler shell and said lower clamping shelf of said left-side coupler shell are compressed against said upper clamping shelf of said right-side coupler shell and said lower clamping shelf of said right-side coupler shell.

15. The rigid self-sealing pipe clamp system of claim 1 wherein said upper clamping shelf of said right-side coupler shell and said lower clamping shelf of said right-side coupler shell are integrally and resiliently attached to said cylindrical pipe-clamping body of said right-side coupler shell, said cylindrical pipe-clamping body of said coupler shell being tensioned about said first pipe end and said second pipe end when said upper clamping shelf of said right-side coupler shell and said lower clamping shelf of said right-side coupler shell are compressed against said upper clamping shelf of said left-side coupler shell and said lower clamping shelf of said left-side coupler shell.

16. The rigid self-sealing pipe clamp system of claim 1 wherein said at least one alignment ridge of said left-side coupler shell and at least one alignment ridge of said right-side coupler shell engage said at least one alignment ridge-receiving channel of said right-side coupler shell and said at least one alignment-receiving ridge of said left-side coupler shell, thereby providing structural support and maintaining a proper at least one alignment of said first pipe end relative to said second pipe end necessary to promote a fluid-communicating seal over time.

17. A rigid self-sealing pipe clamp system comprising:
a left-side coupler shell and a right-side coupler each including and defined by
an upper clamping shelf;
a lower clamping shelf;
a cylindrical pipe-clamping body;
at least two O-ring receiving channels;
an upper shelf seal-receiving channel;
a lower shelf seal-receiving channel;
at least one alignment ridge;
at least one alignment ridge receiving channel; and
at least four bolt-receiving apertures;
wherein said upper clamping shelf, said lower clamping shelf, said cylindrical pipe-clamping body, said at least two O-ring receiving channels, said upper shelf receiving channel, said lower shelf receiving channel, said at least one alignment ridge, said at least one alignment ridge receiving channel, and said at least four bolt receiving apertures are in functional and structural combination;
at least two O-rings;
at least two shelf seals;
at least four bolts; and
at least four nuts;
wherein said left-side coupler shell is attachable to said right-side coupler shell;
wherein said at least two O-ring receiving channels of said left-side coupler and said at least two O-ring receiving channels of said right-side coupler are structured to receive said at least two O-rings;
wherein said at least one upper shelf-receiving channel of said left-side coupler, said at least one lower shelf-receiving channel of said left-side coupler, said at least one upper shelf-receiving channel of said right-side coupler, and said at least one lower shelf-receiving channel of said right-side coupler are structured to receive said at least two shelf seals;
wherein said at least four bolt-receiving apertures of said left-side coupler and said at least four bolt-receiving apertures of said right-side coupler are structured to receives said at least four bolts and said at least four nuts;
wherein said left-side coupler shell and said right-side coupler shell are structured and arranged to receive, mate, and retain a first pipe end and a second pipe end;
wherein said left-side coupler shell and said right-side coupler shell are compressible by application of said at least four bolts and said at least four nuts;
wherein said at least two O-rings and said at least two shelf seals are engaged and retained by said left-side coupler shell and said right-side coupler shell against said first pipe end and said second pipe end; and
wherein said at least two O-ring receiving channels of said left-side coupler and said at least two O-ring receiving channels of said right-side coupler are structured to receive said at least two O-rings;
wherein said at least one upper shelf-receiving channel of said left-side coupler, said at least one lower shelf-receiving channel of said left-side coupler, said at least one upper shelf-receiving channel of said right-side coupler, and said at least one lower shelf-receiving channel of said right-side coupler are structured to receive said at least two shelf seals;
wherein said at least four bolt-receiving apertures of said left-side coupler and said at least four bolt-receiving apertures of said right-side coupler are structured to receives said at least four bolts and said at least four nuts;
wherein said left-side coupler shell, said right-side coupler shell, and said at least two O-rings are assembled concentric to said first pipe end and said second pipe end;
wherein said left-side coupler shell and said right-side coupler shell are symmetrical in function, and are assembled in mirror image to each other, surrounding said first pipe end and said second pipe end;
wherein said at least two O-rings prevent fluid leakage around said first pipe end and said second pipe end;
wherein said at least two shelf seals prevent fluid leakage between said upper clamping shelf of said left-side coupler shell and said upper clamping shelf of said right-side coupler shell, and between said lower clamping shelf of said left-side coupler shell and said lower clamping shelf of said right-side coupler shell;
wherein said left-side coupler shell and said right-side coupler shell are compressed against said first pipe end, said second pipe end, and each other when said at least four bolts are threaded into said at least four nuts;
wherein said first pipe end and said second pipe end are held together by the compression of said left-side coupler shell and said right-side coupler shell;
wherein said left-side coupler shell and said right-side coupler shell are aligned on an axis parallel with said first pipe end and said second pipe end by engagement of said at least one alignment ridge of left-side coupler shell with said at least one alignment ridge receiving channel of said right-side coupler shell, and by engagement of said at least one alignment ridge of right-side coupler shell with said at least one alignment ridge receiving channel of said left-side coupler shell;
wherein said upper shelf seal-receiving channel of said left side coupler shell and said lower shelf seal-receiving channel of said left side coupler shell are parallel with said at least one alignment ridge of said left-side coupler shell and said at least one alignment ridge receiving channel of said left-side coupler shell for the purpose of ensuring consistent and complete seal of said at least two shelf seals;
wherein said upper shelf seal-receiving channel of said right side coupler shell and said lower shelf seal-receiving channel of said right side coupler shell are parallel with said at least one alignment ridge of said right-side coupler shell and said at least one alignment ridge receiving channel of said right-side coupler shell for the purpose of ensuring consistent and complete seal of said at least two shelf seals;
wherein said left-side coupler shell, said right-side coupler shell, said at least two O-rings, and said at least two shelf seals form a sealed inner volume for communicating a flow of water when assembled about said first pipe end and said second pipe end;
wherein said left-side coupler shell and said right-side coupler shell each comprise a semi-cylindrical sleeve encompassing 180° of rotation, including a raised boss at each end of said left-side coupler shell and said right-side coupler shell, each including one of said at least two O-ring receiving channels, each comprising a groove recessed into an inner face of said left-side coupler shell and said right-side coupler shell;
wherein said left-side coupler shell and said right-side coupler shell together comprise a resilient annular channel forming a clinched engagement embracing said first pipe end and said second pipe end;
wherein said upper clamping shelf of said left-side coupler shell and said lower clamping shelf of said left-side coupler shell are integrally and resiliently attached to said cylindrical pipe-clamping body of said left-side coupler shell, said cylindrical pipe-clamping body of said left-side coupler shell being tensioned about said first pipe end and said second pipe end when said upper clamping shelf of said left-side coupler shell and said lower clamping shelf of said left-side coupler shell are compressed against said upper clamping shelf of said right-side coupler shell and said lower clamping shelf of said right-side coupler shell;
wherein said upper clamping shelf of said right-side coupler shell and said lower clamping shelf of said right-side coupler shell are integrally and resiliently attached to said cylindrical pipe-clamping body of said right-side coupler shell, said cylindrical pipe-clamping body of said coupler shell being tensioned about said first pipe end and said second pipe end when said upper clamping shelf of said right-side coupler shell and said lower clamping shelf of said right-side coupler shell are compressed against said upper clamping shelf of said left-side coupler shell and said lower clamping shelf of said left-side coupler shell;
wherein said at least one alignment ridge of said left-side coupler shell and at least one alignment ridge of said right-side coupler shell engage said at least one alignment ridge-receiving channel of said right-side coupler shell and said at least one alignment-receiving ridge of said left-side coupler shell, thereby providing structural support and maintaining a proper at least one alignment of said first pipe end relative to said second pipe end necessary to promote a fluid-communicating seal over time;
wherein said left-side coupler shell and said right-side coupler shell are structured and arranged to receive, mate, and retain a first pipe end and a second pipe end;
wherein said left-side coupler shell and said right-side coupler shell are compressible by application of said at least four bolts and said at least four nuts;
wherein said at least two O-rings and said at least two shelf seals are engaged and retained by said left-side coupler shell and said right-side coupler shell against said first pipe end and said second pipe end;
wherein said at least two O-rings, said left-side coupler shell, and said right-side coupler shell are arranged in functional combination to form a water-tight interior, thereby sealing the fluid contents of said first pipe end and said second pipe end; and
wherein said at least two O-rings, said left-side coupler shell, and said right-side coupler shell are arranged in functional combination to form a water-tight interior, thereby sealing fluid contents of said first pipe end and said second pipe end.

18. The rigid self-sealing pipe clamp system of claim 17 further comprising a kit including: said left-side coupler shell, said right-side coupler shell, said at least two O-rings, said at least two shelf seals, said at least four bolts, said at least four nuts, and a set of user installation instructions.

19. A method of using a rigid self-sealing pipe clamp system comprising the steps of: placing a first pipe end and a second pipe end inside a left-side coupler shell and a right-side coupler shell, aligning said left-side coupler shell and said right-side coupler shell; inserting at least four fasteners into at least four bolt-receiving apertures in said left-side coupler shell and said right-side coupler shell; and compressing said left-side coupler shell and said right-side coupler shell around said first pipe end and said second pipe end by threading said at least four fasteners into said at least four nuts.
